(19) United States
(12) Patent Application Publication
(10) Pub. No.: US 2015/0197455 A1
(43) Pub. Date: Jul. 16, 2015

(54) SPIN-ON-GLASS ASSISTED POLISHING OF ROUGH SUBSTRATES

(71) Applicant: InMold Biosystems A/S, Taastrup (DK)

(72) Inventor: Henrik Pranov, Espergaerde (DK)

(73) Assignee: InMold Biosystems A/S, Taastrup (DK)

(21) Appl. No.: 14/363,263

(22) PCT Filed: Dec. 6, 2012
(86) PCT No.: PCT/DK2012/000130

§ 371 Date: Jun. 5, 2014

(30) Foreign Application Priority Data
Dec. 8, 2011 (DK) PA 2011 00957 8

(51) Int. Cl. C04B 41/50; C04B 41/87; C04B 41/00; B05D 3/04; B05D 1/00

(52) U.S. Cl. CPC C04B 41/5035; B05D 3/0453; B05D 1/005; C04B 41/009; C04B 41/87

(57) ABSTRACT

A method produces a smooth surface on a rough substrate. The rough substrate is coated with a film or particles of spin-on-glass (SOG) dissolved in a solvent using spin coating, spray coating or dip coating. The SOG is made to reflow by using thermal melting and solvent thinning. The reflow is done in an atmosphere containing a partial pressure of the solvent. The reflow allows the SOG to partially melt and to decrease the surface roughnesss of the film. The SOG is cured by thermal curing or UV exposure radiation curing into a hard durable and chemical inert silicon dioxide film. The SOG can be hydrogen silsesquioxane or methyl silsesquioxane dissolved in either methyl isobutyl ketone or volatile methyl siloxanes. The method can include embossing, chemical mechanical polishing, etching and functionalizing the surface. The substrate can be a cast, mould or form for producing a polymer or a glass replica.

### FIELD OF THE INVENTION

The present invention relates to a method and apparatus for smoothening rough surfaces.

### BACKGROUND OF THE INVENTION

In construction, mechanical and consumer applications, it is desirable to have a perfectly planar surface to defined areas of articles for use as low friction surfaces. A method of reducing surface roughness of such articles in a higher quality than by using state-of-the-art tools and methods is desirable, in particular if such reduction of the surface roughness of the said articles may be performed at a relative low cost. In particular articles made of hard metals or metal alloys, such as steel or aluminum, or ceramic materials such as wolfram carbide or titanium oxide, which are time consuming and expensive to polish would be advantageous to reduce the surface roughness of.

Steel surfaces may be polished, but there are several challenges in this process. One is the purity of the steel that is very critical as even very small impurities will give rise to small holes or particle release during polishing, thus reducing the quality of the polishing. Another limiting factor of this method is the different hardness of the different phases of the steel, limiting the surface roughness obtainable to about 5 nm, as the softer phase will be removed faster than the harder phase. Furthermore steel is difficult to structure using conventional methods, as dry etching methods such as reactive ion etching is not possible, therefore only allowing for isotropic etching, greatly limiting obtainable micro and nano topographies.

Furthermore, steel may be corroded by contact with many different corrosive species, such as H2S or halogens. Hence would a smoothening process also providing an anti-corrosion property of the substrate be advantageous. A method to reduce the surface roughness while simultaneously improving the anti-corrosion properties of the substrate is here presented.

### OBJECT OF THE INVENTION

It may be seen as an object of the present invention to provide an improved method for smoothening metallic or ceramic substrates, in particular polymer or glass shaping tools.

It is an object of the present invention to present a technological solution, where a smooth film may be formed on a rough substrate, thus reducing polishing cost, increasing the surface anti-corrosion quality by reducing the number of defects and decreasing the surface roughness.

It is a further object of the invention to present a technological solution where polishing of the surface may be done without removing material from the substrate itself, thus increasing the number of applicable re-polishing processes.

It is a further object of the invention to present a technological solution where durable micro or nanostructures may be manufactured by mechanical embossing methods, directly on to substrates with a relative high surface roughness.

It is a further object of the invention to provide a method where the coating may be easily removed without damaging the initial substrate.

It is a further object of the invention to provide a method where the coating has an adhesion strength above 20 MPa.

It is a further object of the invention to provide a method where the coating method intrinsically has fewer pin-holes than provided by vacuum deposition techniques.

It is a further object of the present invention to provide an alternative to the prior art.

### SUMMARY OF THE INVENTION

The invention here presented regards the application of a thin film of spin-on-glass (SOG) directly on the surface of rough substrate, whose surface roughness is to be lowered. Non-limiting examples of such substrates could be part of a polymer or glass shaping tool, an oil pipeline, engine, ship hull, airplane, heat exchanger, chemical processing equipment, pump or other equipment where a low surface roughness would give an enhanced functionality, such as lower friction, or lower wear due to mechanical abrasion. Furthermore does the SOG film in its final state provide excellent anti-corrosion properties, as the film is virtually pin-hole free and consisting of fused silica, which is chemical resistant to most chemical species except fluoric acid (HF) and certain reactive species used as slurry in the CMP process when combined with mechanical abrasive forces.

A solution of SOG is deposited on the substrate using conventional coating technologies, such as spin coating, spray coating, dip coating or electrostatic coating. The viscosity of the SOG coating is lowered to a point where the surface energy forces (such as surface tension) will make the coating flow. This viscosity condition will herein be defined as a liquid film, whereas the opposite condition (where the film or coating does not flow due to surface energy forces) is defined as solid or ductile. The viscosity may be lowered by different means, or a combination of different means. One mean is absorption of solvent in a solvent thinning process; the substrate comprising the coating of SOG is placed in a controlled atmosphere containing at least a 50% saturated partial pressure (at the given temperature) of a suitable solvent for the dissolution of SOG. Examples of such solvents are Methyl isobutyl ketone (MIBK) or volatile methyl siloxanes (VMS). The SOG coating on the substrate is allowed to absorb solvent from the controlled atmosphere until the SOG becomes liquid (or dissolved). Another mean is to increase of the temperature of the SOG coating. Upon increasing temperatures, the viscosity will be lowered, however increased temperatures will also facilitate cross-binding within the SOG coating, thereby increasing the viscosity of the coating. This cross-binding will be further facilitated by the presence of oxygen in the form of gaseous oxygen or in the form of water vapor, which therefore must be minimized. A requirement for the reflow process is that the SOG is compatible with the surface (wets the surface spontaneously). Many ceramic or metallic surfaces have this inherent property, and those who does not have the property may be surface treated to obtain this property. If the substrate is either inherent compatible or compatible through surface treatment to allow for spontaneous wetting of the surface, the SOG may form a pin-hole free coating with a low surface roughness. The reason for the inherent pin-hole freedom of the coating is that the energetic state where the surface energy is lowest, will be the state where the air/SOG interface area is minimized. If a pin-hole exist, the air/SOG interface will be able to be minimized by filling the pin-hole with SOG. See FIG. 7 for an illustration of this. The surface treatment of the substrate is typically done using an oxygen containing plasma to incorporate oxygen groups in the substrate surface. Examples of a native inherent surface is aluminum, which has a thin native oxide layer, and an example of a surface requiring surface treatment is some types of stainless steel, which needs to have incorporated oxygen groups in the surface to be compatible. After the SOG solution has formed a smooth film, any remaining solvent is evaporated in order to form a smooth, solvent-free SOG film. This film may be structured by mechanical means if a nanostructured texture is demanded, as previously disclosed (PCT/DK2011/000075). When the desired surface topography (smooth or nanostructured) is achieved, the SOG film is cured in order to crosslink, thus forming a thin layer of fused silica, which is covalently bond to the substrate. Curing methods may be thermal curing, where the substrate and the SOG film is heated to a temperature above 200 C. in the presence of oxygen, or it may be an irradiation curing by e.g. UV radiation where the ionizing irradiation generates free radicals in the SOG molecules, thus promoting cross binding in the SOG film, and covalent binding between the SOG film and the substrate. After the curing process, the fused silica film may be further smoothened by the use of the conventional CMP process, or be etched by conventional means such as Hydrofluoric etchants in order to obtain a well-defined surface roughness. The film may furthermore be structured or coated by conventional processes such as dry etching through a mask (Reactive Ion Etching or Deep Reactive Ion Etching), isotropic etching through a mask by the use of wet or dry etch, metalization or functionalization using silane or siloxane chemistry where substances such as hexamethyl di siloxane (HMDS), 1H,1H,2H,2H-PERFLUORODECYLTRICHLOROSILANE (FDTS), 1H,1H,2H,2H-PERFLUOROOCTYLTRICHLOROSILANE (FOTS) or other functionalized silanes or siloxanes are covalently coupled to the surface to obtain a given surface functionality, typically increased slip properties or better wetting properties against different liquids, such as but not limited to molten polymers in polymer shaping processes.

### DETAILED DESCRIPTION OF THE INVENTION

Conventional metallic or ceramic surfaces used in processing industry and other applications are often treated to decrease the surface roughness. This is often done to decrease friction of the surface, to increase reflectivity, or to improve other functional properties of the surface. The prevalent method to decrease the surface roughness is abrasive diamond polishing, where a paste of diamond powder dispersed in a liquid or a wax is rubbed onto the surface, thus decreasing the surface roughness. This method is relative expensive, especially on complex parts or large parts, where the polishing has to be performed manually. Alternatives such as electropolishing is also used, however only a limited number of materials are compatible with this process. It would therefore be advantageous if a process to reduce surface roughness where present, that had the following features: Material independent, applicable to complex and large geometries, cost effective and being fast with a high throughput. If such a method could furthermore include other advantageous properties, such as providing corrosion resistance, good chemical functionalization ability, and the possibility to make a controlled nanometer scale surface topography, it would be even a further advantageous method.

We have invented such a method, and will in the following disclose the invention in detail.

A first rough substrate consisting of a metallic or ceramic material whose surface roughness is to be reduced by at least a factor of 2. This substrate could by way of example and not by way of limitation be the whole or part of a polymer or glass shaping tool, oil pipeline, engine, ship hull, airplane, heat exchanger, chemical processing equipment or a pump.

This substrate is subject to a method for producing a topographically smooth surface, said method comprising at least the following steps:
applying a spin-on-glass onto at least one part of a rough substrate consisting of a metal, metal alloy or ceramic material, preferably steel, aluminum or wolfram carbide.
bringing the said polishing film to a reflow condition at a reflow temperature in an atmosphere containing a partial pressure of a solvent capable of dissolving the said spin-on-glass upon which the polishing film is spontaneously smoothened.
curing the said polishing film of spin-on-glass by cross-linking the individual molecules, thereby transforming it into a solid ceramic material primarily consisting of silicon dioxide.

A method according to the above description, where the surface is durable or chemically inert.

A method according to the above description, where the reflow process takes place in an atmosphere containing an at least 20% saturated partial pressure of solvent.

A method according to the above description, where the reflow process takes place at a temperature between −20° C. and 200° C.

A method according to the above description, where the surface roughness of the substrate is reduced by at least a factor of 2, more preferably by a factor of 3, more preferably by a factor of 4, even more preferably by a factor of 5 and most preferably by a factor of 10 or more.

A method according to the above description, where the surface roughness of the substrate is initially above 5 nm, more preferably above 15 nm, more preferably above 50 nm, even more preferably above 100 nm, even more preferably above 250 nm and most preferably above 500 nm.

A method according to the above description comprising
the substrate consisting of steel or aluminum, having a surface roughness of at least 100 nm and being a part of a polymer or glass shaping tool
the spin-on-glass primarily consisting of hydrogen silsesquioxane (HSQ), methyl silsesquioxane (MSQ) or a mixture thereof and the solvent consisting of a volatile organic solvent or a volatile siloxane solvent.
the coating method being a spray coating process forming a spin-on-glass layer with a thickness of at least 200 nm
the reflow process being solvent assisted reflow in an atmosphere containing at least 50% saturation of MIBK or VMS at a temperature of at least 5° C. for a time of at least 2 minutes
the curing step being a thermal curing at a temperature between 200° C. and 800° C.
the resulting surface roughness of the final part being less than 30 nm.

A method according to the above description, wherein said substrate is at least part of a polymer or glass shaping tool, an oil pipeline, an engine, a ship hull, an airplane, a heat exchanger, a chemical processing equipment, or a pump.

A method according to the above description, where the smoothening film is further smoothened by a mechanical or chemical-mechanical polishing process or an embossing process.

A method according to the above description, where the smoothening film is subsequently structured or coated by conventional silicon dioxide structuring or coating methods such as reactive ion etching, deep reactive ion etching, isotropical wet or dry etching or metallization by sputtering or electron beam evaporation.

Any polymer or glass replica made by a polymer or glass casting, molding or extrusion process using the substrate comprising a smoothened surface, made by any of the above described methods, as a shaping surface.

The present invention discloses a method for the decreasing of the surface roughness of a metallic or ceramic substrate. It consists of 4 mandatory and 4 optional steps: (1) An initial rough, conventional ceramic, metal or metal alloy substrate, (2) coating of the rough, conventional substrate with a film or particles of a spin-on-glass, (3) reflow polishing of the coating consisting of spin-on-glass using either a volatile spin-on-glass dissolvable solvent in its gaseous form, or using thermal induced reflow (melting) of the spin-on-glass coating at an elevated temperature, or a combination of the presence of gaseous solvent and elevated temperature to induce the reflow, (4) optional structuring or further planarization by a mechanical embossing process, (5) curing of the polishing film to form cross linked silicon dioxide, (6) optional chemical mechanical planarization (CMP), chemical mechanical polishing or mechanical polishing of the polishing film, and (7) optional structuring of the polishing film by conventional lithographic, etching or metallization methods, and (8) optional surface functionalization by a self assembled monolayer of a fluor-carbon-silane.

Each step will now be described in detail.

The initial rough substrate whose surface roughness is to be lowered may be made in any material capable of being heated to 200 C., and is preferably made from steel, but may also consist of other metals routinely used as substrate materials in the chemical processing industry, such as brass, aluminum, tungsten carbide, copper, titanium or bronze.

The said substrate is coated by a spin-on-glass (SOG), preferably by spin coating or spray coating. By spin coating the substrate is placed on a rotational stage with the surface perpendicular to the axis of rotation. A liquid solution of SOG is dispensed on the surface, where after the substrate is rotated, distributing the SOG solution to form a thin film covering the surface. During rotation the solvent of the SOG evaporates, leaving a non-mobile, ductile polishing film. By spray-coating, a precise amount of SOG solution is sprayed on the surface, either in the form of a film consisting of individual SOG-particles contacting on the particle edges or as a dense homogeneous film.

During or after the coating process, a portion of the solvent evaporates, making the polishing film non-liquid. The evaporation is normally a spontaneous process. After the coating process, the substrate and the SOG coating is placed in a chamber with a controlled temperature and partial pressure of solvent. The SOG film will absorb solvent from the gas-phase spontaneously, and given the right temperature and partial pressure of solvent, the film will become liquid, thus spontaneously lowering the surface roughness in order to minimize surface energy with respect to the film-air interface. The process may be performed at room temperature with a saturated atmosphere of solvent (e.g. MIBK or VMS), or it may be performed at a slightly increased temperature (30 C.-120 C.) using a lower partial pressure of solvent. The typical process time is mainly related to the evaporation dynamics of the solvent reservoir and the adsorption of the gas-phase solvent to the SOG-film, which is dependent on the substrate temperature and the atmosphere temperature. The process time may be decreased by decreasing the substrate temperature in order to increase condensation rates of the solvent on the substrate. After the adsorption and the reflow of the SOG-film, the atmosphere is evacuated of solvent, allowing the SOG-film to reduce the content of solvent, thereby becoming non-liquid.

In this state, the surface topography of the SOG-film may optionally be further manipulated. A flat or nanostructured master structure may be embossed into the ductile surface to make a (inverse) replica of the surface topography of the master structure. The master nanostructure may be topographically flat or comprising a functional or decorative nanostructure. After this optional step, the substrate comprising the SOG-film is cured.

Curing of the polishing film preferably takes place by heating the substrate to a certain transition temperature where the SOG reacts, thereby forming a solid, hard ceramic material primarily consisting of silicon oxide with the same or lower surface roughness as the SOG film. By rapidly heating the SOG coated substrate, the SOG film and the surface of the substrate will expand due to thermal expansion before the cross-linking of the SOG happens. This raises the temperature level where the cured SOG film is stress free. At temperatures above this level, the SOG film is subject to a tensile stress, and at temperatures below this temperature, the SOG film is subject to a compressive stress. Depending on the temperature level of the application, this zero-stress temperature level may be set by choosing the heating rate and temperature level.

After curing, the surface topography of the substrate now comprising a silicon oxide film may optionally be further manipulated. In case of planar substrates Chemical Mechanical Planarization (CMP) of the polishing film is made using a CMP tool, normally consisting of a rotating pad with slurry on, and a non-concentric rotation tool fixture, wherein the substrate is placed, so as the planar surface is in contact with the pad soaked with slurry. The CMP process removes the material in contact with the pad, ensuring that the surface of the polishing film is made highly planar, with very low surface roughness surface, typically in the sub-nm range. In the case of a non-planar substrate, or in the case of a substrate not adaptable to the CMP process, a general chemical mechanical polishing process may be employed. The physical principle of this process is the same as in CMP, but instead of a CMP tool, manual or robot-assisted free-form polishing is performed using CMP slurry. The CMP process is described in the literature, e.g. in “Silicon processing for the VLSI Era—Vol. IV <<Deep-submicron Process Technology>>” by S. Wolf, 2002, ISBN 978-0961672171, Chapter 8 <<Chemical mechanical polishing>> pp. 313-432.

Optionally the smoothened polishing film may be structured by lithographical means, preferably by e-beam lithography or optical lithography, etching processes, preferably isotropic wet etching or anisotropic reactive ion etching, metallization processes, preferably e-beam evaporation, sputtering or chemical vapor deposition.

Optionally the smooth or structured polymer shaping tool may be functionalized with a self assembled monolayer of a fluor-carbon-silane to increase the slip-properties of the polymer shaping tool.

A feature of the coated substrate is that the silicon oxide coating may be selectively removed using selective silicon dioxide etchants, such as Hydrofluoric acid. This feature is particularly important in applications where wear takes place during use of the substrate, and it is desirable to be able to extend the lifetime of the substrate. Examples of this is polymer molding tools, where the surface topography is slowly altered during repetitive molding using the substrate as a shaping surface, and once the surface topography is out of specification, it is desirable to make a re-polishing. However, using conventional polishing methods, only a limited number of re-polishing processes may be performed, as material is removed from the substrate, hence altering the overall geometry until this gets out of specification. By the selective removal of the silicon dioxide coating, the substrate may be re-coated and polished without altering the overall geometry in an accumulative way.

By substrate is meant any metallic or ceramic substrate, whose surface roughness is to be reduced by the disclosed invention.

By rough is meant a substrate whose surface roughness is higher than the desired surface roughness.

By smooth is meant a substrate whose surface roughness is less than or equal to the desired surface roughness. Examples of requirements for a surface to be smooth depends on the application that the surface is to be used in, however typical examples within the field of polymer or glass molding for surface roughness requirements of a smooth surface is that the surface has a surface roughness of less than 100 nm, preferably less than 50 nm, more preferably less than 25 nm, even more preferably less than 10 nm, even more preferably less than 5 nm and most preferably less than 2 nm.

By durable is meant a surface which is resistant to wear in industrial processes. The exact criteria depends on the application of the substrate. For the polymer or glass shaping process, durable means that the coating will not delaminate, crack or otherwise fail during 1000 repetitive shaping processes. For a chemical process equipment, such as a tube, a pump, a heat exchanger, an oil pipeline, durable will mean that the coating will not fail within one year of normal continuous use.

By chemically inert is meant chemical resistance to the process streams which the substrate will contact during normal use. By way of example and not by way of limitation, the desire for chemical inertness is e.g. resistance to aqueous solutions containing trace amounts of halogens which will corrode steel or aluminum, and hence is a coating with a chemically inert substance, such as silicon dioxide desirable.

By surface roughness is meant the average vertical deviations of a real surface from its desired primary or macroscopic form. This parameter is often defined as Ra in the literature. Large deviations defines a rough surface, low deviations define a smooth surface. Roughness can be measured through surface metrology measurements. Surface metrology measurements provide information on surface geometry. These measurements allow for understanding of how the surface is influenced by its production history, (e.g., manufacture, wear, fracture) and how it influences its behavior (e.g., adhesion, gloss, friction).

Surface primary form is herein referred as the over-all desired shape of a surface, in contrast with the undesired local or higher-spatial frequency variations in the surface dimensions.

Example on how to measure surface roughness are included in the document from the International Organization for Standardization ISO 25178 which collects all international standards relating to the analysis of 3D areal surface texture.

Roughness measurements can be achieved by contact techniques, e.g. by use of profilometers or atomic force microscope (AFM), or by non-contact techniques, e.g. optical instruments such as interferometers or confocal microscopes. Optical techniques have the advantages of being faster and not invasive, i.e. they do physically touch the surface which cannot be damaged.

Surface roughness values herein referred are intended as to be the values of the average peak to valley height of the profile along the surface primary form within a 30 μm by 30 μm sampling area with a minimum resolution of 100 nm (distance between neighboring sampling points). The values of average valley depth are defined as the average depth of the profile below the mean line along the surface primary form sampling length and the values of the average peak height are defined as the average height of the profile above the mean line along the surface primary form sampling length.

By smoothening or polishing is meant the process of making the polishing film surface smooth.

By spin-on-glass solution is meant a liquid solution of material that upon curing is capable of forming a solid, non-ductile ceramic material, such as silicon dioxide. As a way of example and not by way of limitation the said liquid solution of ceramic material precursors could be hydrogen silsesquioxane (HSQ) in Methyl isobutyl ketone (MIBK) or methyl silsesquioxane (MSQ) Methyl isobutyl ketone (MIBK), capable of forming a ductile film of HSQ or MSQ by evaporation of the solvent (MIBK). HSQ and MSQ will cross-link into a solid material, primarily consisting of SiO₂ upon thermal curing at 600° C. for 1 hour.

By dissolving is meant the process of transforming a material from a non-liquid state into a liquid state by solvent absorption.

By non-liquid is meant a material unable of being permanently, non-elastically deformed upon normal handling. In particular we here mean a film that does not significantly change geometry spontaneously after evaporation of the solvent before the curing process. A test for this is to see if a change in film thickness by more than 10% by flow induced by gravitational forces parallel to the surface within a time span of 24 hour occurs.

By reflow condition is meant a state wherein the viscosity of the SOG film or particles are reduced so they may alter their surface topography significantly in a spontaneous process driven by the SOG-atmosphere interface energy minimization within a time span of 24 hours. In this context “significantly” is relative to the initial surface roughness of the film or the particles, and should be interpreted as a decrease of Ra of at least 5% within the 24 hours.

By spontaneously is meant a process taking place without any external mechanical assistance, such as direct mechanical contact, as done in embossing processes, or induced centrifugal forces, as done in spin coating. In particular spontaneous is meant to be a process driven by energy or enthalpy minimization of the SOG-film—atmosphere interface. Under normal conditions, this energy or enthalpy minimization will be obtained when the SOG-atmosphere interface has the lowest possible area, which will be obtained by a topographically smooth interface, and hence a topographically smooth SOG-film surface.

By coating is meant the process of applying a film of the spin-on-glass to the shaping surface of the said mold or mold insert. As a way of example and not by way of limitation the said coating method could comprise spin coating, spray coating or coating by submersion (dip coating) of the mold or mold insert into the said SOG solution.

By curing is meant the process of transforming the spin-on-glass into the corresponding solid glass. This is typically done by covalent cross-linking of smaller molecular entities into a mesh or grid structure, forming a solid ceramic substance. As a way of example and not by way of limitation the said curing method could be e.g. thermal curing where the ceramic precursor material is heated to a temperature where the cross linking takes place spontaneously, or the curing method could be a plasma curing where a plasma interacts chemically with the ceramic precursor material, thereby cross linking the ceramic precursor material, or the curing method could be an irradiation curing, where ionizing irradiation (e.g. UV exposure or electron irradiation) forms radicals in the ceramic material precursor or precursor solvent, causing the precursor to crosslink.

By saturated partial pressure is meant the maximum partial pressure of a species in its gaseous state at a given temperature and at a given total pressure.

By CMP is meant the combined smoothening and planarization process using a chemical etchant combined with the mechanical process of lapping. A more thorough description can be found here: Silicon processing for the VLSI Era—Vol. IV <<Deep-submicron Process Technology>>—S Wolf, 2002, ISBN 978-0961672171, Chapter 8 <<Chemical mechanical polishing>> pp. 313-432.

By chemical mechanical polishing is meant a free-form polishing process using the same polishing principles as CMP, where the lapping process is substituted by a free form polishing process, which may be manual (by hand), tool assisted, robot assisted or made purely by robotics.

By spin-on-glass (SOG) is meant the soluble substance capable of being cured into a hard ceramic substance, preferably silicon dioxide. Non-limiting examples of spin-on-glass are Hydrogen Silsesquioxane (HSQ) or Methyl Silsesquioxane (MSQ).

By shaping surface is meant a surface of a substrate which is used as a mechanical constriction in a shaping process. In particular this is meant to be part of an injection molding tool, a compression molding tool or an extrusion roller used for the shaping of polymeric or glass parts.

In some embodiments the substrate comprises a surface roughness larger than 10 nm, preferably larger than 50 nm, more preferably more than 100 nm, even more preferably more than 200 nm, and most preferably more than 400 nm before the coating step.

In some embodiments the coating step comprises a spin coating process, where the tool or tool insert is placed on a rotational stage. A volume of the liquid SOG solution is placed on the desired shaping surface of the tool or tool insert. Rotation of the tool or tool insert ensures that the SOG solution is evenly distributed on the desired shaping surface.

In some embodiments the coating step comprises a spray coating process, where the liquid SOG solution is forced through small openings in order to generate small droplets of liquid SOG solution. These droplets are sprayed on the desired tool or tool insert surface to generate an evenly distributed film of SOG solution on the desired surface.

In some embodiments the reflow step comprises placing the substrate comprising the film of spin-on-glass in a chamber with a well-controlled and uniform temperature and partial solvent gas-pressure distribution.

In some embodiments the reflow step comprises a thermal and solvent assisted process in a protected atmosphere to prevent reaction of the SOG with components of the atmosphere, in particular oxygen. The SOG film comprising adsorbed solvent is heated and surface tension makes the SOG reflow to minimize surface area, thus reducing the surface roughness.

In some embodiments the curing step comprises a thermal curing process where the film of structured ductile ceramic material precursor is heated to a curing temperature for a given period of time, thereby transforming the smooth film of SOG into a solid, smooth ceramic material by cross-linking of the SOG and/or remnants of the SOG solvent.

In some embodiments the curing step comprises a plasma curing process where the film of structured SOG is subjected to a plasma, the plasma inducing cross-linking of the SOG itself and/or remnant SOG solvent, thereby transforming the film of ductile SOG and/or SOG solvent into a structured solid ceramic material.

In some embodiments the curing step comprises an irradiation curing process, where the film of spin-on-glass is irradiated by ionizing radiation, non-limiting examples being electron beam radiation, UV-radiation, gamma-radiation or x-ray radiation. The ionizing radiation generates free radicals in the spin-on-glass, thereby cross-linking the spin-on-glass to form a solid glass.

In some embodiments the optional chemical mechanical planarization process comprises the polymer shaping tool comprising the polishing film being brought in non-concentric rotating contact with a pad with chemically active slurry, which removes material from the polishing film until the surface of the polishing film is planar with a smooth surface.

In some embodiments the optional chemical mechanical polishing step comprises the polymer shaping tool comprising the polishing film being polished using a chemically active slurry, where the polishing process is done by hand-polishing, tool-assisted hand polishing, robot assisted polishing or robot polishing.

In some embodiments the optional mechanical polishing step comprises the polymer shaping tool comprising the polishing film being polished using an abrasive slurry, where the polishing process is done by hand-polishing, tool-assisted hand polishing, robot assisted polishing or robot polishing.

All of the features described may be used in combination so far as they are not, incompatible therewith. Thus, spin coating, spray coating, evaporation, thermal curing, plasma curing, irradiation curing, injection molding, blow molding, coining and compression molding may be used in any combination or combined, e.g. part of the process may be carried out by spray coating and part by spin coating.

### BRIEF DESCRIPTION OF THE FIGURES

The method and apparatus according to the invention will now be described in more detail with regard to the accompanying figures. The figures show one way of implementing the present invention and is not to be construed as being limiting to other possible embodiments falling within the scope of the attached claim set.

FIG. 1 shows the definition of the substrate (1) and its associated surface roughness (2) of the substrate before coating.

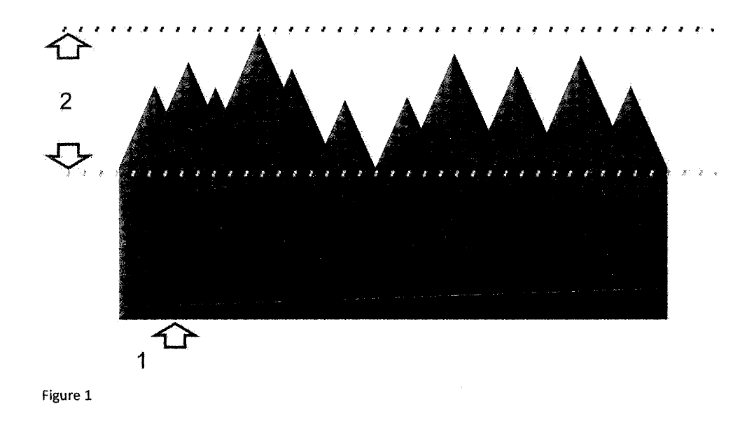

FIG. 2 shows the substrate (1) coated with a dense film of spin-on-glass (3) with an associated surface roughness (4).

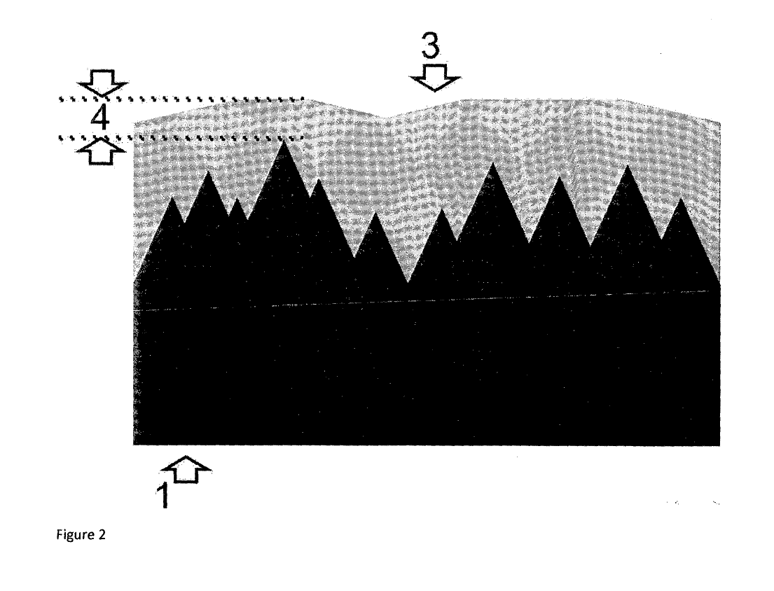

FIG. 3 shows the substrate (1) coated with a particle based film of spin-on-glass (5).

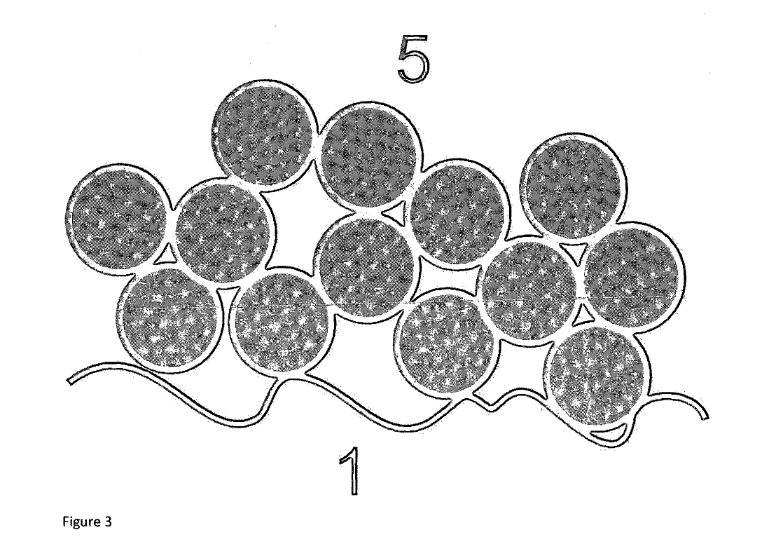

FIG. 4 shows the particles (6) during solvent uptake, slowly being fused together.

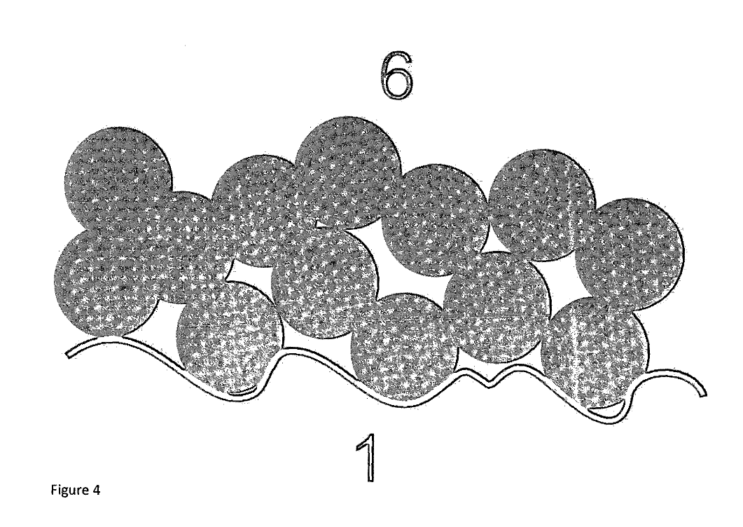

FIG. 5 shows the final reflowed film (7) on the substrate (1).

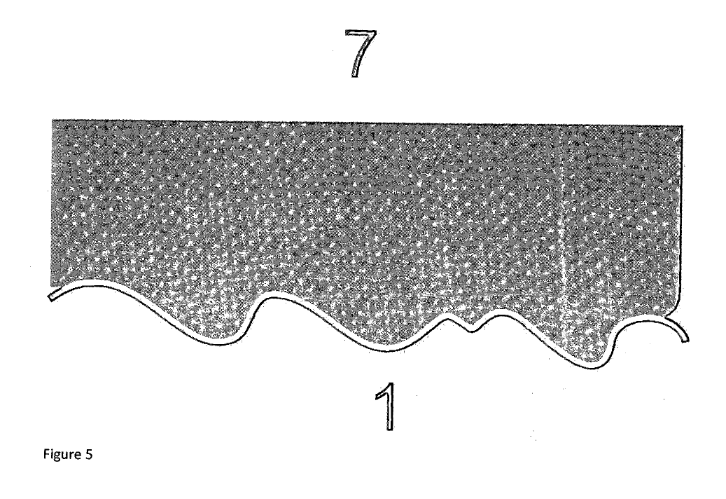

FIG. 6 shows a flow-chart of a method according to a first aspect of the invention. The dotted steps are optional, whereas the full-line marked steps are required. An initial SOG-compatible substrate with a surface roughness which is to be lowered by this method (11) is coated with a spin-on-glass solution (12), the SOG-film is reflowed in order to decrease surface roughness and eliminate pin-holes with a subsequent process step where solvent is allowed to evaporate forming a non-liquid, smooth polishing film of spin-on-glass (13), the smooth polishing film is optionally mechanically structured or further smoothened (14), the SOG polishing film is then cured to form a hard material consisting primarily of silicon dioxide (15), the cured polishing film is optionally further smoothened by chemical mechanical planarization or polishing (CMP) to form an even smoother polishing film (16), which may further optionally be structured or coated by conventional silicon substrate methods such as lithography, etching or metal deposition (17). Subsequent to this the surface may be optionally chemically functionalized (18) by a self assembled monolayer of a fluor-carbon-silane, non-limiting examples being perfluorodecyltrichlorosilane (FDTS) or perfluorooctyltrichlorosilane (FOTS).

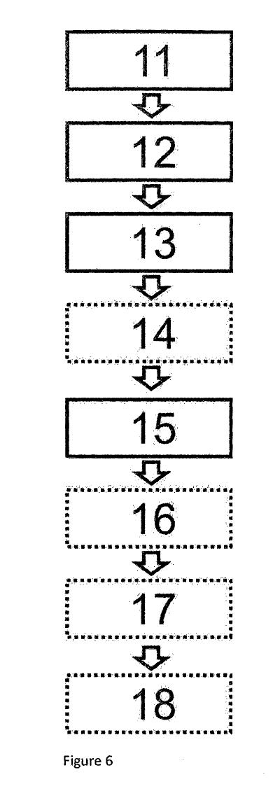

FIG. 7 shows a situation (top of FIG. 1) where a pin-hole (2) has been created. By reflowing (situation shown at the bottom) the SOG, spontaneous filling the pin-hole with SOG occurs (3), as the combined interface area between the SOG/substrate and the air is minimized, thus being energetically and enthalpically more favorable.

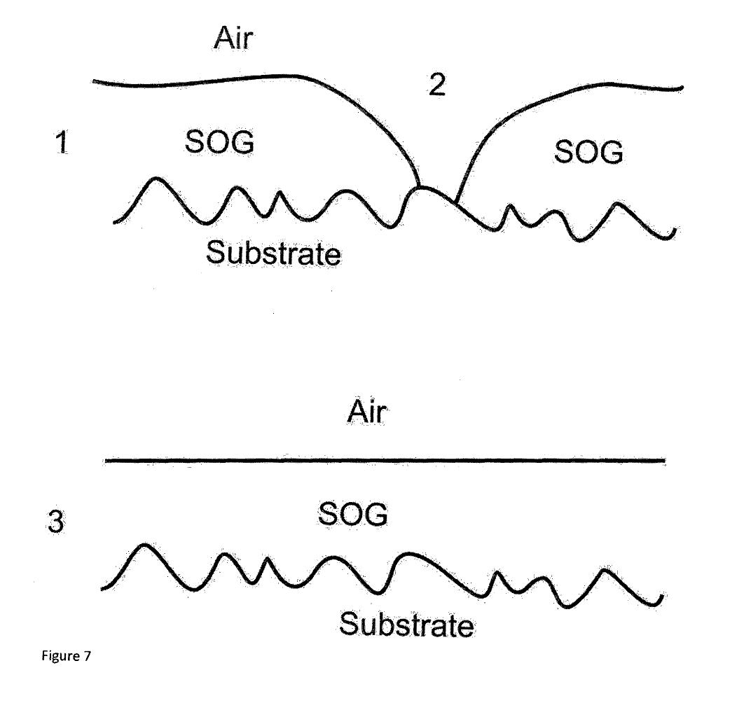

### DETAILED DESCRIPTION OF AN EMBODIMENT

In a first example a planar substrate comprising an insert for a petri dish mold is made of steel by milling it to a surface roughness measured by atomic force microscopy (AFM) to be 200 nm. The spin-on-glass is HSQ dissolved in MIBK (FOx-16 from Corning). FOx-16 is coated onto the polished planar stainless steel surface using spin coating at 1500 RPM for 60 s, forming a 600 nm thick HSQ film with a surface roughness of 40 nm. The tool insert is heated to 40° C. with a 95% partial pressure of MIBK for 8 hours resulting in a surface roughness of 5 nm. The solvent is removed from the atmosphere by nitrogen purging for 15 minutes, whereby the solvent of the SOG-film evaporates. The substrate is cured at 600° C. for one hour with a temperature ramping of 300° C./hour, transforming the soft HSQ polishing film into a solid ceramic material, primarily consisting of SiO₂. The cured tool insert is chemical mechanical planarized on a Alpsitec E460 CMP machine for 2 minutes to obtain a surface roughness of 1 nm. The tool insert is then used for injection molding of 1 mm thick polystyrene replicas at a melt temperature of 250° C., a mold temperature of 40° C., a cycle time of 28 s and an injection velocity (linear filling velocity parallel to the shaping surface) of 2 m/s on a 55T injection molding machine, whereby the 1 nm surface roughness smooth surface is replicated into the polystyrene petri dish replicas, giving superior optical clearness. This process is repeated 1 million times in order to make multiple replicas of the structure.

In a second example the plates of a plate-plate heat exchanger made of cast aluminum is coated by spray coating of HSQ (Fox-25 from Corning). The plates are assembled to form the heat exchanger, and a gas at 25 C. with 95% partial pressure of VMS (Semiconductor grade rinse from Corning) is purged through the heat exchanger for 15 minutes, resulting in a surface roughness of 25 nm. the heat exchanger is subsequently purged with 400 C. hot atmospheric air for 30 minutes, curing the HSQ to form a hard, chemically inert layer of silicon oxide, thereby decreasing flow resistance and improving the anti-corrosive properties of the heat exchanger.

In a third example a steel oil pipeline tube is plasma cleaned and spray coated at the inner side with HSQ (17-20 mass percent in MIBK from Gelest Inc.). The tube is subsequently filled with 5 C 100% partial pressure MIBK for 2 hours, thereby reducing the surface roughness to 30 nm. The HSQ is cured by illuminating with EUV radiation with a wavelength of 120 nm with a spread of 20 nm. Subsequently the silicon oxide coating is functionalized using a gas-phase reaction with FDTS, thereby making the inner surface wax- and oil repellent, minimizing the risk of wax blockage buildup in the tube, while simultaneously reducing the flow resistance, giving a higher capacity of the pipeline (at a given pumping pressure capacity).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

All patents and non-patent references cited in the present application are also hereby incorporated by reference in their entirety.

1. A method for producing a topographically smooth surface, said method comprising:
applying a spin-on-glass polishing film onto at least one part of a rough substrate consisting of a metal, metal alloy or ceramic material;
bringing said polishing film to a reflow condition at a reflow temperature in an atmosphere containing a partial pressure of a solvent capable of dissolving said spin-on-glass upon which the polishing film is spontaneously smoothened, and
curing said polishing film of spin-on-glass by cross-linking the individual molecules, thereby transforming it into a solid ceramic material primarily consisting of silicon dioxide.

2. A method according to claim 1, wherein the surface is durable or chemically inert.

3. A method according to claim 1, wherein the reflow process takes place in an atmosphere containing an at least 20% saturated partial pressure of solvent.

4. A method according to claim 1, where the reflow process takes place at a temperature between −20° C. and 200° C.

5. A method according to claim 1, wherein the surface roughness of the substrate is reduced by at least a factor of 2.

6. A method according to claim 1, wherein the surface roughness of the substrate is initially above 5 nm, more preferably above 15 nm, more preferably above 50 nm, even more preferably above 100 nm, even more preferably above 250 nm and most preferably above 500 nm.

7. A method according to claim 1 comprising
the substrate consisting of steel or aluminum, having a surface roughness of at least 100 nm and being a part of a polymer or glass shaping tool;
the spin-on-glass primarily consisting of hydrogen silsesquioxane (HSQ), methyl silsesquioxane (MSQ) or a mixture thereof and the solvent consisting of a volatile organic solvent or a volatile siloxane solvent;
the coating method being a spray coating process forming a spin-on-glass layer with a thickness of at least 200 nm;
the reflow process being solvent assisted reflow in an atmosphere containing at least 50% saturation of MIBK or VMS at a temperature of at least 5° C. for a time of at least 2 minutes;
the curing step being a thermal curing at a temperature between 200° C. and 800° C.;
the resulting surface roughness of the final part being less than 30 nm.

8. The method according to claim 1, wherein said substrate is at least part of a polymer or glass shaping tool, an oil pipeline, an engine, a ship hull, an airplane, a heat exchanger, a chemical processing equipment, or a pump.

9. A method according to claim 1, wherein the polishing film is further smoothed by a mechanical or chemical-mechanical polishing process or an embossing process.

10. A method according to claim 1 wherein the polishing film is subsequently structured or coated by conventional silicon dioxide structuring or coating methods.

11. A polymer or glass replica made by a polymer or glass casting, molding or extrusion process using the substrate comprising a smooth surface made by the process of claim 1 as a shaping surface.

12. A method according to claim 1, wherein the rough substrate consists of a metal, metal alloy or ceramic material selected from steel, aluminum or wolfram carbide.

13. A method according to claim 3, wherein the reflow process takes place at a temperature between −20° C. and 200° C.

14. A method according to claim 5, wherein the surface roughness of the substrate is reduced by a factor of 3.

15. A method according to claim 5, wherein the surface roughness of the substrate is reduced by a factor of 4.

16. A method according to claim 5, wherein the surface roughness of the substrate is reduced by a factor of 5.

17. A method according to claim 5, wherein the surface roughness of the substrate is reduced by a factor of 10.

18. A method according to claim 10, wherein the subsequent structuring or coating method is selected from reactive ion etching, deep reactive ion etching, isotropical wet or dry etching or metallization by sputtering or electron beam evaporation.
